(19) United States
(12) Patent Application Publication
(10) Pub. No.: US 2005/0273489 A1
(43) Pub. Date: Dec. 8, 2005

(54) Multimedia system for a mobile log

(75) Inventors: Yuval Joshua Pecht, Kiryat Ono (IL); Arnon Yaar, Ramat Hasharon (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 11/005,012

(22) Filed: Dec. 7, 2004

Related U.S. Application Data
(60) Provisional application No. 60/576,802, filed on Jun. 4, 2004.

(51) Int. Cl. G09B 19/00; G06F 15/16

(52) U.S. Cl. 709/203

(57) ABSTRACT

A multimedia server has a communication handler, a log setup unit, and a data receiving unit. The communication handler interfaces with a wireless device using at least one wireless protocol. The log setup unit sets up a mobile log and designates user access rights. The data receiving unit receives multimedia content from a wireless source and enters the received content into a designated mobile log.

### CROSS-REFERENCE TO RELATED APPLICATIONS

This application claims the benefit of U.S. Provisional Patent Application No. 60/576,802 titled “UNIBLOG” filed on Jun. 4, 2004, the disclosure of which is incorporated by reference in its entirety.

### FIELD AND BACKGROUND OF THE INVENTION

1. Field of the Invention

The present invention relates to a multimedia mobile logging system and, more particularly, to a method, a multimedia system, a wireless device, and a multimedia server for performing mobile logging from the wireless device.

2. Description of the Related Art

Web logs (commonly known as blogs) are a relatively recent phenomenon in the Internet community. Though some web logs date back as early as the mid 1990s, their popularity did not really take off until 2001. Simply put, a blog is a website which acts as an online repository of the writer's thoughts, typically in chronological order so the latest entries are at the top of the page.

Initially blogs were updated manually by bloggers familiar with HTML. Once technologies appeared that allowed a wider audience to publish blogs automatically, interest in them took off rapidly. There are now many hundreds of personal blogs available, covering a variety of topics. New technologies are continually being incorporated into these online journals to expand their capabilities and the audience they serve.

Initially blogs were a text-only medium. In a bid to present a richer story, many bloggers began posting photographs in addition to their entries. Almost overnight, photo-only blogs began appearing, where few words are posted, and the entire story is told through photographs.

The next technological leap for the blogs was audio. Again, this was a situation where the more technically inclined led the way, adding posts of digitized audio clips either recorded directly onto a computer or digitized from an analog source. New services such as AudBlog™ have simplified audio blogging to a level similar to voice mail. With AudBlog™, a service of ListenLabs, once an account is set up, the user adds an audio message to his audlog by dialing a phone number, entering a PIN number, and recording the message at the tone.

Even before audio has become a full-blown component of web logging (blogging), video was already being experimented with. Video logs are not viewed as a replacement to text, pictures or audio-only postings. Rather, video logs provide the author with another logging tool. Unlike the television or the print media, the Internet allows the multimedia commentary to live side by side with text, each medium supporting the expressions of the other media. Furthermore, video blogging need not serve for occasional commentary. The portability of most consumer-level video camera technology means that users can express themselves in documentary or narrative style film on a daily basis, and post the narrative to a blog to share with viewers.

Alongside with the mobile revolution, a new form of blogs (denoted moblogs) has evolved, with content provided by camera enabled mobile phones. Moblogging is also performed from other wireless devices with multimedia capabilities, such Danger's Hiptop®, a popular wireless phone/camera/Web device which supports a variety of high-speed data communication applications, including web logging by email.

Most multi-media content services currently availably in the market are operator-based, and commonly require software installation in the wireless device. The operator purchases the value-added service (VAS) and provides storage space for its subscribers. Alternatively, the service is provided by the cellular operator but log storage is provided by a third party. Several examples of the wireless multimedia services in the related art are presented below.

In the related art, one type of service is the web-based multimedia album, such as the Lightsurf PictureMail and VideoMail. The multimedia album does not provide the organization and chronological context of the blogging experience. Additionally, PictureMail & VideoMail are standards-based services that support MMS for GSM, CDMA, and other mobile communication networks. The user edits the multimedia content into an MMS and sends the MMS to the PictureMail/VideoMail service, which stores the received content in a secure online album. However, the use of MMS for content delivery creates constraints on the type and format of storable content and its delivery mechanism. The content is limited to the capacities of the MMS, and cannot be delivered to the album by email, Internet, or data streaming. Lightsurf® also does not alleviate client issues such as the complex process required to assemble and transmit the MMS.

A second solution in the related art is the Cognima Snap™ Media Album. Cognima Snap™ automatically uploads photos and video clips from a camera phone to a Service Provider's online photo album. The photos and video are automatically uploaded without the subscriber needing to send messages or use menus on the phone. Unlike the Lightsurf VideoMail, Cognima Snap™ tackles the user interface problem, and enables uploading of pictures in two clicks. Cognima Snap™, however, deals specifically with simplifying the uploading of images and videos into an album (not a web log), and does not provide an overall solution of content delivery in a wide variety of multimedia formats.

The Newbay™ FoneBlog is a server side blogging solution which runs over mobile phone standards (MMS, SMS and WAP). It runs on carrier grade, scalable systems designed to interface with SMSC, MMSC and email systems, and can be integrated with operators' web systems. After setting up a website, users send SMS, MMS or email messages to a special mobile number. FoneBlog creates a new entry for each message and places it at the top of the user's website. Previous entries are moved down and each day a new page is created.

However, FoneBlog does not offer true multimodality of the loggable multimedia content. Since FoneBlog is only a server-side solution, the blogging functionality of FoneBlog is limited to the capabilities of the user's mobile phone. Multimodal content can be transmitted to FoneBlog using only the built-in formats and communication protocols provided with the wireless device. Thus, multimodality is only achieved to a certain extent in Foneblog, when sending blog entries via MMS. Additionally, the Newbay™ FoneBlog does not handle the user interface problem. In order to update a log, the user has to compose and send an SMS, MMS or an email message. The task of sending multimedia items using current telephone interfaces is generally complex (i.e., take a picture, save it on the phone, compose an email, get the attachment, find the email address and send the email). Foneblog, therefore, does not enable simple and convenient logging.

An additional approach to mobile logging is Nokia's Lifeblog system. Nokia Lifeblog is a mobile phone and a personal computer (PC) application solution that keeps an organized multimedia diary of the items collected with a mobile phone. Lifeblog automatically organizes the multimedia items on the mobile phone into a chronological record that may be browsed, searched, edited, and saved. In order to clear up some memory space on the mobile phone, the logged items can be transferred from the mobile phone to a PC. The items logged on the PC may then be transferred to a web log service, such as Six Apart's TypePad™ . Nokia's Lifeblog does not provide true mobile logging, as entering content items into a web log is a two-step process, which requires synchronizing the mobile phone with a personal computer, and only then transferring the content items to the log server.

The blogs in the related art do not provide a complete solution for mobile log users. Current “multimedia” blogs do not offer true multimodality and handle a limited number of media (usually single- or dual-media only). One of the most important blog features for users is ease of use. However, selecting and sending the content from many mobile logging services is cumbersome and inconvenient, as the user must use functions and navigate through menus which were not designed for mobile logging. Furthermore, once the blog is stored, there is no system that presents logged multimedia content to handsets in a way that fits their capabilities, including bandwidth issues, special (yet standard) and custom media formats, display size, and so forth.

There is thus a widely recognized need for, and it would be highly advantageous to have, a mobile log for the logging of rich, multimodal multimedia content received from a wireless device into a sharable storage.

### SUMMARY OF THE INVENTION

In view of the shortcomings in the related art, according to a first aspect of the present invention, there is provided a multimedia server. The multimedia server has a communication handler, a log setup unit, and a data receiving unit. The communication handler interfaces with a wireless device using at least one wireless protocol. The log setup unit sets up a mobile log and designates user access rights. The data receiving unit receives multimedia content from a wireless source and enters the received content into a designated mobile log.

According to a second aspect of the present invention, there is provided a multimedia server having a communication handler, a log setup unit, and a data receiving unit. The communication handler interfaces with a wireless client. The log setup unit sets up a mobile log and designates user access rights. The data receiving unit receives multimedia content from a wireless source and enters the received content into a designated mobile log.

According to a third aspect of the present invention, there is provided a multimedia server having a log setup unit and a data receiving unit. The log setup unit sets up a mobile log and designates user access rights. The data receiving unit receives upstreamed multimedia content from a wireless source and enters the received content into a designated mobile log.

According to a fourth aspect of the present invention, there is provided a multimedia server having a communication handler, a log setup unit, and a data receiving unit. The communication handler interfaces with a wireless device using at least one wireless protocol. The log setup unit sets up a mobile log and designates user access rights. The data receiving unit receives audio content in a digital format from the wireless device and enters the received content into a designated mobile log.

According to a fifth aspect of the present invention, there is provided a wireless device. The wireless device includes a multimedia content generator and a logging client. The multimedia content generator generates multimedia content items, and the logging client implements at least one wireless logging protocol used for interfacing to a multimedia mobile log server, in order to log the multimedia content items into a mobile log at the server.

According to a sixth aspect of the present invention, there is provided a wireless device having a multimedia content generator and a logging client. The multimedia content generator generates multimedia content items, and the logging client provides a dedicated mobile logging user interface.

According to a seventh aspect of the present invention, there is provided a wireless device having a multimedia content generator and a logging client. The multimedia content generator generates multimedia content items. The logging client consists of a media capture buffer for storing captured data, a coder for encoding captured data into a content item having a specified media format, a log-entries generator for combining multiple content items into a transmittable log entry, a server interface for sending and receiving log entries, and a graphical user interface for interfacing with a user.

According to an eighth aspect of the present invention, there is provided a mobile logging system having a wireless device for generating and sending multimedia content, and a multimedia server. The multimedia server includes a communication handler for interfacing to the wireless device, a log setup unit for setting up a wireless log and designating user access rights, and a data receiving unit for receiving multimedia content from the wireless device and for entering the received content into a designated mobile log.

According to a ninth aspect of the present invention, there is provided a method for providing a multimedia mobile log, by performing the following steps. A mobile log is set up and user access rights are designated. Next, multimedia content is received for the mobile log from a wireless device using a wireless protocol. The received content is then entered into a designated mobile log.

According to a tenth aspect of the present invention, there is provided a method for wireless mobile logging by performing the following steps. A mobile log is set up and user access rights are designated. Next, multimedia content is created on a wireless device. The multimedia content is sent from the wireless device to the multimedia server, and the sent content is entered into a designated mobile log.

According to a eleventh aspect of the present invention, there is provided a method for mobile logging from a wireless device, by performing the following steps. A logging client is installed on a wireless device. Multimedia content is generated on the wireless device. Next, a connection is made to a mobile log service via the logging client, and the multimedia content is transmitted to the mobile log service for entry into a designated log.

The aspects of the present invention may overcome the above described disadvantages present in the related art and other disadvantages not described above. The present invention is not necessarily required to overcome any of the disadvantages described above, and the aspects of the present invention may not overcome any of the problems described above. The appended claims should be consulted to ascertain the true scope of the invention.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, illustrative embodiments will now be described, by way of non-limiting examples only, with reference to the accompanying drawings, in which:

FIG. 1 is a simplified illustration of a content flow to and from a mobile log according to an illustrative, non-limiting embodiment of the present invention.

FIG. 2 illustrates exemplary types of multimedia content which are supported by the mobile log according to an illustrative, non-limiting embodiment of the present invention.

FIG. 3 is a simplified block diagram of a multimedia server according to a first illustrative, non-limiting embodiment of the present invention.

FIG. 4 is a simplified block diagram of a communication handler in accordance with an illustrative, non-limiting embodiment of the present invention.

FIG. 5 is simplified block diagram of a multimedia server according to another illustrative, non-limiting embodiment of the present invention.

FIGS. 6a and 6b are a simplified block diagram and process flow diagram, respectively, of a multimedia mobile log according to an illustrative, non-limiting embodiment of the present invention.

FIGS. 7a-7d illustrate examples of system architectures for a multimedia mobile log server according to an exemplary, non-limiting embodiment of the present invention.

FIGS. 8a and 8b are simplified block diagrams of a wireless device for mobile logging according to a first and second illustrative, non-limiting embodiments of the present invention.

FIG. 9 is a simplified block diagram of a handset client for a wireless device according to an illustrative, non-limiting embodiment of the present invention.

FIG. 10 is a simplified flowchart of a method for providing a multimedia mobile log according to an illustrative, non-limiting embodiment of the present invention.

FIG. 11 is a simplified flowchart of a method for mobile logging from a wireless device according to an illustrative, non-limiting embodiment of the present invention.

FIG. 12 is a simplified flowchart of a method for wireless mobile logging according to an illustrative, non-limiting embodiment of the present invention.

### DETAILED DESCRIPTION OF ILLUSTRATIVE, NON-LIMITING EMBODIMENTS

The present invention will now be described in detail by describing illustrative, non-limiting embodiments thereof with reference to the accompanying drawings. In the drawings, the same reference characters denote analogous elements.

The illustrative, non-limiting embodiments relate to a multimedia log which is accessible over a network, and which provides multimedia logging from a wireless device (denoted herein a mobile log). Specifically, these exemplary embodiments can be used to provide multimedia mobile logging functionality for a wide range of media formats. Typical logging functions include log setup, entering and viewing content, updating, and controlling access to the logs.

Before explaining at least one embodiment of the present invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Wireless devices, such as mobile telephones, are now equipped with a wide spectrum of multimedia capabilities. In addition to traditional audio telephony signal, mobile phones now communicate by SMS text messages, MMS messages, email, and the Internet. Current mobile log services are limited in their ability to handle content only in formats used for wireless communication. The exemplary mobile logs described below are applicable to mobile phone users, as well as users of other wireless devices such as personal digital assistants (PDA) and Hiptop® devices.

The exemplary embodiments described in greater detail below provide a personal storage space in which a user can maintain a sharable, chronological record of multimedia content from his or her mobile phone (or other wireless device). The log is'stored in a centralized storage with presentation capabilities, and which is accessible by user devices (such as a mobile telephone) over a communication network. As a non-limiting example, the following embodiments are directed to a mobile log in the form of a web log (blog) in which the log is a website. However, other forms of mobile logs are possible.

Each log can have one or more sets of access rights, to control access to the logged content. The multimedia log server can handle different media types (i.e., video, photos, audio, text, graphics, etc.) and formats, transmitted over multiple interfaces (i.e., Web-based, cellular-based, POTS-based).

The following exemplary embodiments are directed to a wireless logging from a mobile telephone. The discussion of the embodiments in the context of mobile telephony is for purposes of example only, and is not intended to be limiting.

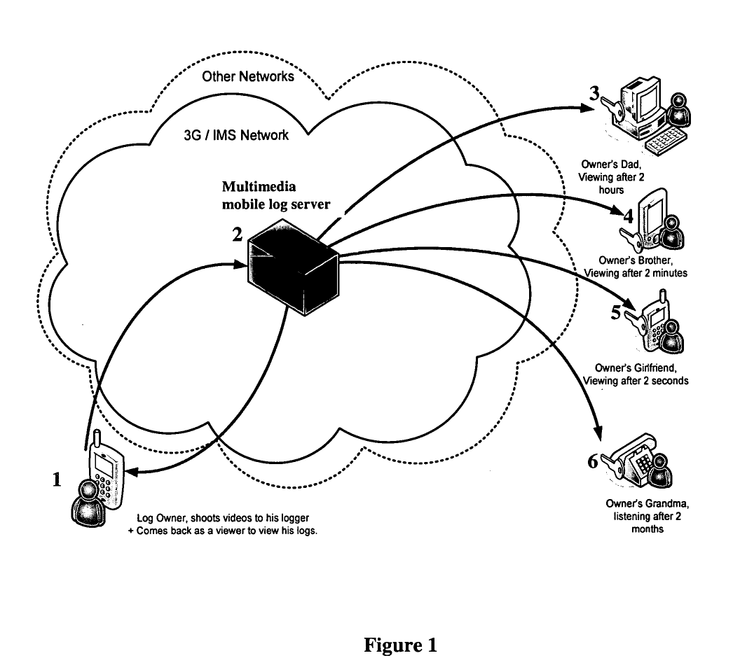

FIG. 1 is a simplified illustration of a content flow to and from a mobile log according to an exemplary embodiment of the present invention. In FIG. 1, the content flow between various devices is illustrated by lines with arrows. In this exemplary embodiment, the log owner records a video clip on his mobile telephone 1. The video clip is then transferred over the cellular telephony network and any other networks in the communication path to the mobile log multimedia server 2, where the video clip is converted into the mobile log. While the logged content remains in the mobile log, the content is available to other users in accordance with their respective access privileges and access capabilities. FIG. 1 shows the logged content being viewed by personal computer 3, PDA 4, mobile telephone 5, 1, and landline telephone 6.

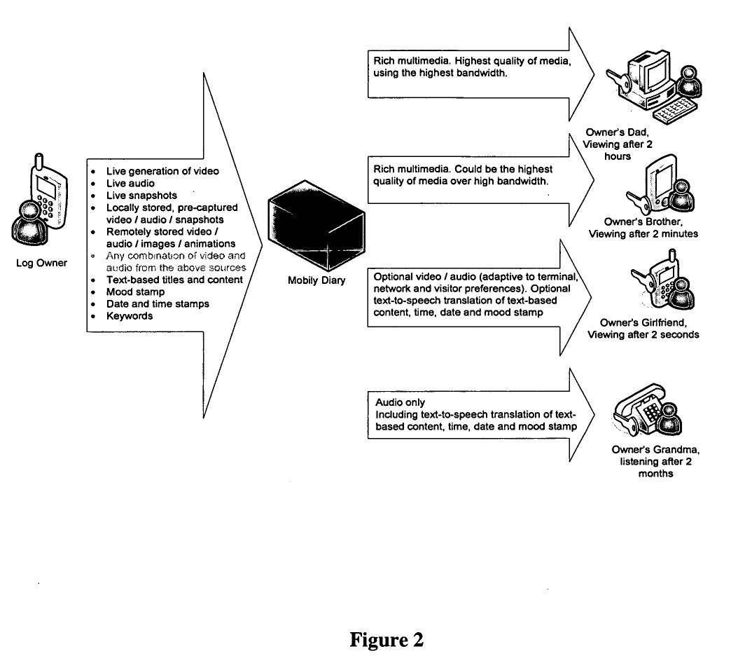

FIG. 2 illustrates types of multimedia content which are supported by the mobile log according to exemplary embodiments of the present invention. A mobile log in these embodiments support a wide range of multimedia content, including live audio, video and images, pre-captured content, text, keywords and so forth. The content may be entered into the log by authorized users, such as the owner, and is viewable by other permitted users as well as by the owner (not shown). The content type, format, and transmission bandwidth depend upon the device accessing the log.

For example, as illustrated in FIG. 2, log owner may provide mobile logs in a wide range of multimedia content including live video, audio, and snapshots, locally stored, pre-captured video, audio, and snapshots, remotely stored video, audio, images and animation. In addition, FIG. 2 illustrates that a log owner may provide mobile logs using text-based titles and content, mood stamp, date and time stamp, and keywords. The mobile log stored in the Mobility Diary may be viewed by the log owner's Dad two hours later, by log owner's Brother two minutes later, log owner's Girlfriend two seconds later, and log owner's Grandmother two months later.

Moreover, as illustrated in FIG. 2, these authorized users may view the mobile log in various different types of multimedia content. FIG. 2 illustrates that log owner's Dad and Brother views the mobile log using high quality media type with a high bandwidth, whereas the log owner's Girlfriend views the mobile log using video and/or audio (an optional text-to-speech translation of the text-based content, time, date, and mood stamp may be provided). Finally, the log owner's Grandmother listens to the mobile log using audio only.

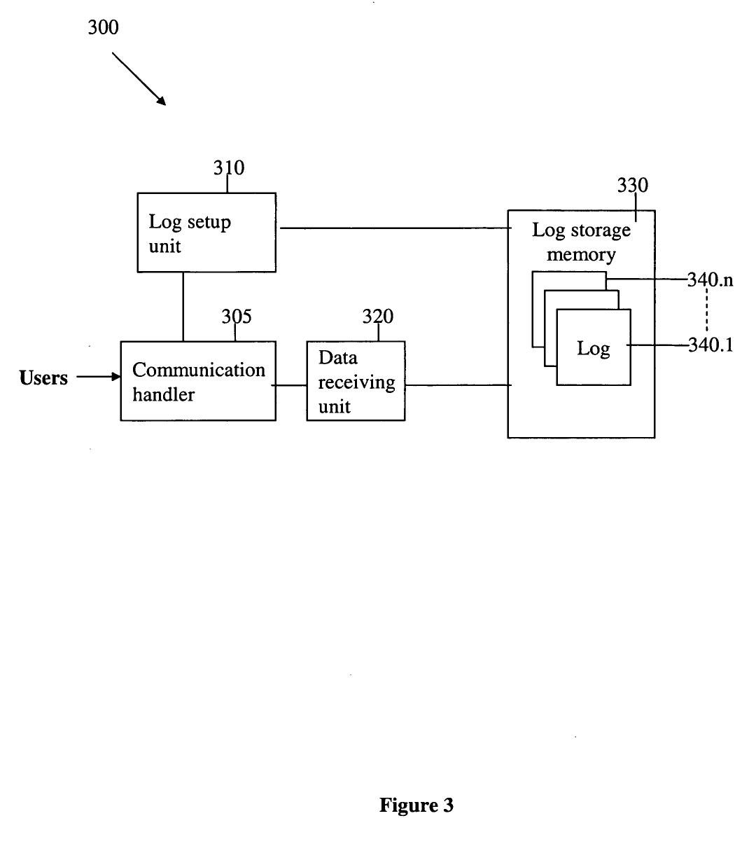

FIG. 3 shows a first exemplary embodiment of a multimedia server according to an exemplary embodiment of the present invention. Multimedia server 300 contains a communication handler 305 (also known as a communication interface), log setup unit 310, data receiving unit 320, log storage memory 330 holding logs 340.1 to 340.n. Each log 340.1 to 340.n may have a number of log entries (not shown). The communication handler 305 interfaces with the wireless devices using at least one wireless protocol, and is preferably equipped to interface with wireline devices as well. The log setup unit 310 performs the initial task of setting up a mobile log and designating user access rights. The data receiving unit 320 receives the multimedia content from a wireless source.

As described below, multimedia content may be communicated by some or all of the following: SMS, MMS, email, Internet (i.e., HTTP), data uploading, data upstreaming, telephony audio, and one or more custom formats. Preferably, the multimedia content types of this exemplary embodiment include some or all of: an audio clip, a video clip, a text message, an image, an audio stream, a video stream, and a tag. The tag may be represented by a graphical icon. The tag is preferably linked to a log entry to provide concise visual information about the entry, such as the type of media, content description (i.e., to select from predefined content options each having an associated tag), content destination (i.e., to designate a destination folder for the content), accessibility, and/or a mood stamp, and may indicate that special processing of the log entry is required.

The communication handler 305 manages communications between users and the other components of the multimedia server 300. Communication handler 305 preferably receives user instructions over a data channel and multimedia content by uploading and/or upstreaming. Multimedia content is commonly accompanied by other information including the originating user, permission status, and so forth. Media streaming allows the storage and retrieval of large media files, which is particularly important for real-time logging of audio and video. For example, a driver may connect to the multimedia server with his mobile phone and upstream the telephony voice signal, thus creating an audio log entry while he is driving. Data upstreaming is generally not supported in the mobile phones, and is preferably provided as a custom service for the mobile device by a provider. This custom service may require software or hardware modifications of the mobile device, as described below.

In the exemplary embodiment, log setup unit 310 receives user instructions via communication handler 305, and sets up a log accordingly. Setting up the log may include tasks such as allocating and formatting memory 330, obtaining required user information, establishing user preferences, and defining access privileges for all users with access to the mobile log. The users with access to the mobile log may be divided into categories. For example, common categories are: owner, publisher, administrator, guest, friend, and user. Setup information is optionally and preferably stored in an administrative database. In the exemplary embodiment, some or all of the preferences, privileges, and so forth established during log setup are modifiable by authorized users at a later time.

Once the mobile log is established, data receiving unit 320 receives multimedia content from the wireless device via communication handler 305. In this exemplary embodiment, data receiving unit 320 processes the content for insertion into the log by converting the received content into a standardized format. For example, by converting the received content into the standardized format, a video clip can be entered into the log in the same manner regardless of whether it was received as an MMS, an uploaded clip, or an email attachment.

In this exemplary embodiment, multimedia server 300 contains data receiving unit 320, which enters the multimedia content received from the user into the designated log. Preferably, the log entries are inserted into the log in an essentially chronological order. The log entries may be accompanied by additional information such as a time stamp. In addition, it is desirable that the data receiving unit 320 examines the user access rights before entering new content into a mobile log. Moreover, it is advantageous to have the data receiving unit 320 link multiple received multimedia content items to form a single log entry and/or link between multiple log entries to form a linked log entry.

In this exemplary embodiment, the mobile logs 340.1 to 340.n are set up on the log storage memory 330, which is integral to the multimedia server 300. Alternatively, some or all of the logs are stored on an external memory, which is accessible by the multimedia server 300.

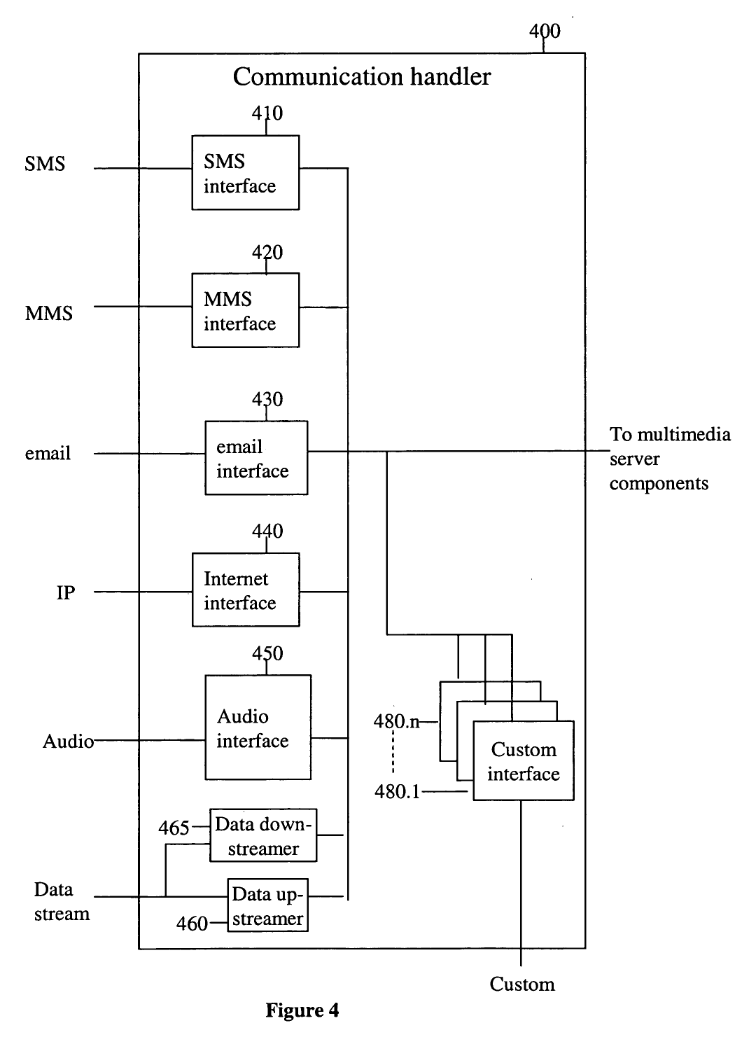

Next, FIG. 4 is a simplified block diagram of a communication handler in accordance with an exemplary embodiment of the present invention. The communication handler contains one or more of communication interfaces for receiving the multimedia content. When a new multimedia protocol is developed, the multimedia server can be upgraded to handle the new protocol by installing an additional communication interface. The communication handler is preferably equipped to receive (and/or send) multimedia content by uploading and/or upstreaming.

In the exemplary embodiment illustrated in FIG. 4, the communication handler 400 contains communication interfaces 410, 420, 430, 440, and 450, for receiving and/or sending the multimedia content. Note that while in FIG. 4 each interface is shown as connecting to a separate communication channel, a channel may be shared by more than one interface. For example, both email and the Internet may be available over a single data channel. Likewise, a given channel may support both incoming and outgoing traffic. For example, upstreaming and downstreaming may be performed over the same channel. Preferably, the interfaces contained in the communication handler 400 are capable of both reception and transmission.

In the exemplary embodiment illustrated in FIG. 4, the communication handler 400 has an SMS interface 410 for communicating SMS messages and/or a MMS interface 420 for communicating MMS messages. Note that landline phones are currently available with digital messaging capabilities. Consequently, the SMS interface 410 may receive SMS messages from a landline phone as well as from a mobile phone.

In the exemplary embodiment illustrated in FIG. 4, the communication handler 400 further includes an email interface 430 for receiving the multimedia content by email. The multimedia content may consist of the email message itself, or may be content contained in the body of email message or in an attachment. The communication handler 400 illustrated in FIG. 4 also includes an Internet interface 440 for receiving the multimedia content over the Internet and an audio interface 450 for receiving and digitizing audio signals. Preferably, the audio signal is an audio telephony signal from a Public Switched Telephone Network (PSTN) or a cellular telephone network.

Moreover, in the exemplary embodiment illustrated in FIG. 4, the communication handler 400 includes a data upstreamer 460 and/or a data downstreamer 465 for receiving upstreamed data from users and downstreaming multimedia items to the users, respectively. Data streaming is particularly important for lengthy audio and video log entries.

In addition, as illustrated in FIG. 4, the communication handler 400 preferably contains one or more custom interfaces 480.1 to 480.n for receiving the multimedia content in a custom protocol(s). A multimedia item sent in a custom protocol is handled by the multimedia server in the same manner as messages in the standard protocols. That is, the multimedia item sent in a custom protocol is directed to an appropriate custom interface, e.g., one of the custom interfaces 480.1 to 480.n. Thus, the multimedia content can be provided from the wireless devices in a currently non-standard protocol, for example, in a dedicated protocol of the mobile logging service.

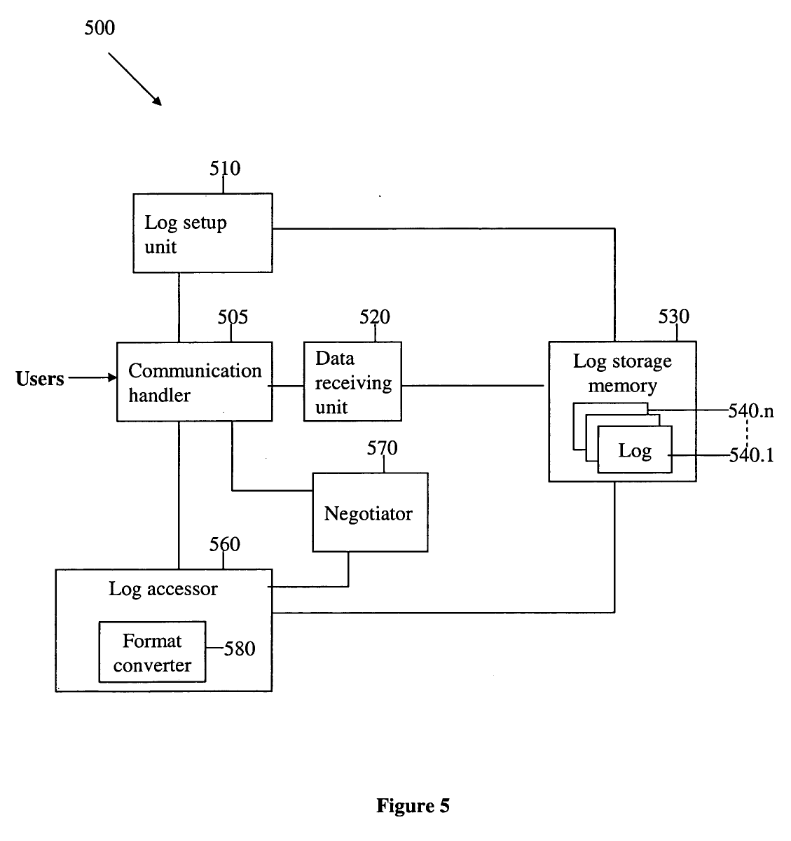

FIG. 5 is a simplified block diagram of a multimedia server according to another exemplary embodiment of the present invention. In the exemplary embodiment illustrated in FIG. 5, the multimedia server 500 contains a communication handler 505, a log setup unit 510, a data receiving unit 520, a log storage memory 530 with logs 540.1 to 540.n, and one or more of: a log accessor 560 and a negotiator 570. The communication handler 505, the log setup unit 510, and the data receiving unit 520 operate analogously to the communication handler 305, the log set up unit 310, and the data receiving unit 320, respectively. The operation of these components was described above with reference to FIG. 3.

In the exemplary embodiment illustrated in FIG. 5, the multimedia server 500 further contains the log accessor 560, which provides user access to mobile logs (other than entering new content) such as viewing and/or editing a mobile log. The log accessor 560 is responsible for transmittal of the logged content to users. The log accessor 560 accesses the log storage memory 530 to provide the authorized users with entries from one or more logs. Thereby, the log accessor 560 enables the users to view the log and/or forward selected log entries to the users. The log accessor 560 retrieves requested log item(s) from the designated log in log storage memory 530, and transfers the requested log item(s) to the communication handler 505 for transmittal to the user over an appropriate channel. Preferably, prior to permitting the user to access a specified log, the log accessor 560 examines the respective user access rights to ensure that the user does not exceed his or her access privileges.

In the exemplary embodiment, the log accessor 560 provides the user with a log content index. The log content index is a concise listing of the log entries. The log entries may be listed with parameters such as time logged, entry type, designated access privileges, and content related details. Preferably, the log entries may be organized and/or filtered by these parameters, both in the index and during user access.

Preferably, the media server 500 contains the negotiator 570, which communicates with the user device to determine device capabilities. These capabilities may include device communication protocols, required formats, and device-related user preferences.

In the exemplary embodiment illustrated in FIG. 5, the log accessor 560 further contains a format converter 580, for converting log entries accessed by a user into a user-compatible format. Format converter 580 formats the retrieved log entry as required by the receiving user device. For example, the log entry may be formatted differently for a mobile phone and a PC, even though the content is transferred to both devices over the Internet.

In addition, the multimedia server may handle administrative, billing, and management functions. The multimedia server preferably contains a database, which holds user information, passwords, management data, and so forth.

In an alternate exemplary embodiment, mobile logging is simplified for the user by installing special-purpose client software on the mobile device, which bypasses standard device menus and controls to provide a simplified user interface. The direct interaction between the multimedia server and the mobile device client also enables the use of special data protocols such as streaming audio/video, in addition to the standard protocols provided with the mobile device.

The multimedia server can be tailored for specific purposes. In one exemplary embodiment, the multimedia server is dedicated to providing audio logging capabilities. An audio log server contains a log setup unit, for setting up audio logs and designating user access rights, a communication handler for interfacing to one or more wireless protocols, and a data receiving unit for receiving audio content in a digital format (such as an MMS, email, Internet, data upstreaming, and data upload) from a wireless source. The audio-only content is logged by the data receiving unit, and retrieved from the log for authorized listeners by the log accessor.

In another exemplary embodiment, the multimedia server is dedicated to streaming of audio and/or video content. The multimedia server contains a log setup unit for setting up a log and designating user access rights and a data receiving unit with upstreaming capabilities. The audio content is upstreamed from a user's wireless device and received by the data receiving unit. Preferably, the content is logged in an audio/video (AV) mobile log by the data receiving unit. In addition, preferably, the multimedia server also has downstreaming capabilities so that the data retrieved from a mobile log by the log accessor can be downstreamed to viewers.

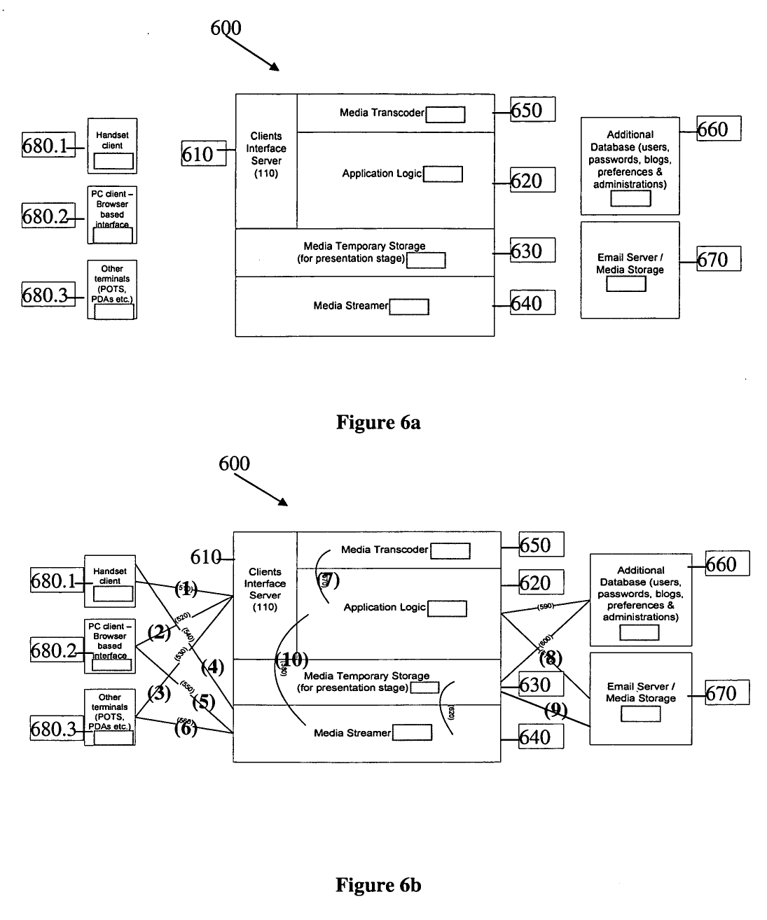

FIG. 6a is a simplified block diagram of a multimedia mobile log according to an exemplary embodiment of the present invention. FIG. 6a illustrates a media server 600, an additional database 660, an email server/media storage 670 and clients 680.1 to 680.3. Exemplary client 680.1 is a handset, client 680.2 is a PC client-browser, and 680.3 represents other terminals such as POT S, PDAs, and so on. The media server 600 has a client interface 610, an application logic 620, a media temporary storage 630, a media streamer 640 and a media transcoder 650. The database 660 and the email server/media storage 670 may be internal or external. Client interface server 610 is a flexible user interface, allowing users to use both standard and proprietary mechanisms to contribute to the mobile log or to view/listen to it. The mobile log is controlled by application logic 620, which manages all server functions, including communications and content processing within the multimedia server 600. The media temporary storage 630 serves for temporary storage of the received content or of the logged content that is being prepared for presentation.

The multimedia content is deposited on the server by the user using a wide range of mechanisms, including: uploading, upstreaming, and via SMS/MMS/Email/web/HTTP. The upstreamed content is received by the media streamer (640), which supports multiple standards, such as Real-Time Transport Protocol (RTP) and Real Time Streaming Protocol (RTSP). Additional communication between the visitor and the server is performed through the client interface 610, in standard ways that encapsulate content (such as WAP/HTTP, email protocols, SMS, MMS). The multimedia content transfer between the multimedia server and the users may be implemented using multiple types of communication technologies (for example, push and pull communications), and for both packet- and circuit-switching networks.

The content can be video, audio, photographic images, graphics, text, keywords, descriptive tags, hyperlinks, etc. The content can be designated as private, public, or have specific access rights assigned to it, which are easily set by the publisher/owner, before, during, and/or after publication.

The media transcoder 650 adapts the incoming content to the format required for processing by the multimedia server 600 and the outgoing content to the format required by the requesting client device. The content may be transcoded during deposit of the content to the multimedia server 600, for efficiency and other reasons.

FIG. 6b is a simplified diagram of a process flow according to an exemplary embodiment of the present invention. FIG. 6b illustrates the data flow between the users 680.1 to 680.3 and the multimedia server 600, the database 660, and the email server/media server 670, as well as the process flow within the server itself. Note that the multimedia content may be communicated between users (680.1 to 680.3) and the multimedia server 600 by upload/download (1, 2, 3), or by streaming (4, 5, 6).

The owner/publisher captures new multimedia content or opens exiting content on the handset wireless client 680.1 with media capture or storage capabilities, and deposits the content on the multimedia server 600 (1 or 4). The content may be transcoded upon the deposit (7) under control of the application logic 620. The received content is stored in a media storage location such as Email server/Media storage 670 (8). The deposited content can be specified as private, public, or have specifically defined access rights assigned to it.

A multimedia mobile log can be viewed by the visitors (680.1, 680.2, 680.3) using a variety of terminals (such wireless devices, PDAs, landline telephones, PCs, and other networked multimedia-devices and content players). During viewing, the content may be transferred from the media storage 670 and moved to the media temporary storage 630 (9) for efficiency purposes while the content is prepared for delivery to the user.

The media server 600 automatically adapts viewed content to the terminal capabilities and to the user's preferences. The content flow can be downstreamed under the control of application logic 620 (10), or may be sent in other ways, such WAP/HTTP, email protocols, SMS, MMS etc.

The media server 600 is a multimodal system, which can tailor logged content to viewer's requirements. Examples of the multimodal conversion include: converting text into speech, playing video as an audio, and tailoring media formats per viewer.

The multimedia server 600 supports many other logging functions, such as password management and content editing or deletion by the owner/publisher. For example, users' passwords and preferences are stored in the database 660. Visitors can respond to the viewed content by posting a message or by sending an SMS/MMS/email to the owner.

Preferably, the multimedia server 600 contains an authentication mechanism which authenticates the user and registers log usage during each access. Billing can then be applied based on usage, storage, general usage fee, etc. Visitors accessing the mobile log with a PC can be required to confirm as cellular users (for example, by getting an updated password by SMS) for billing purposes. The billing functionality enables compensating mobile log owners based on amount of traffic generated.

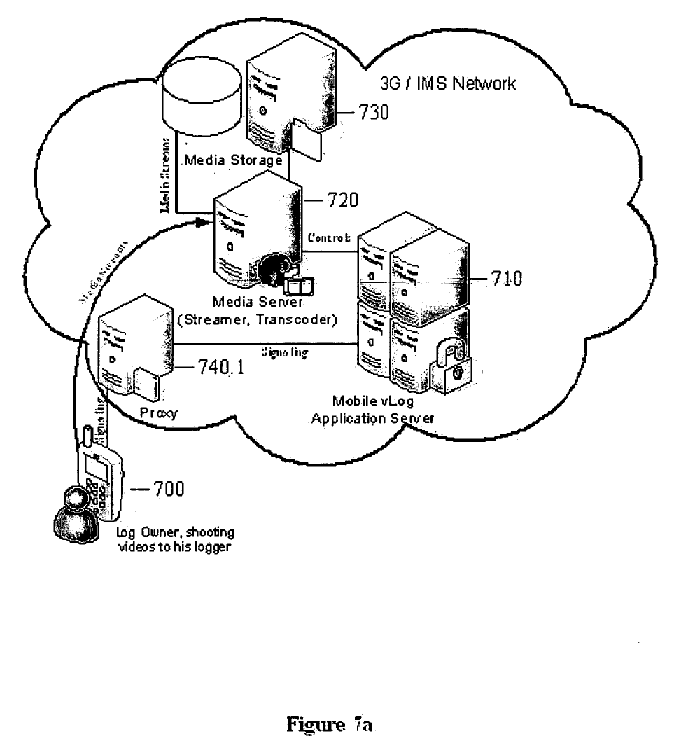

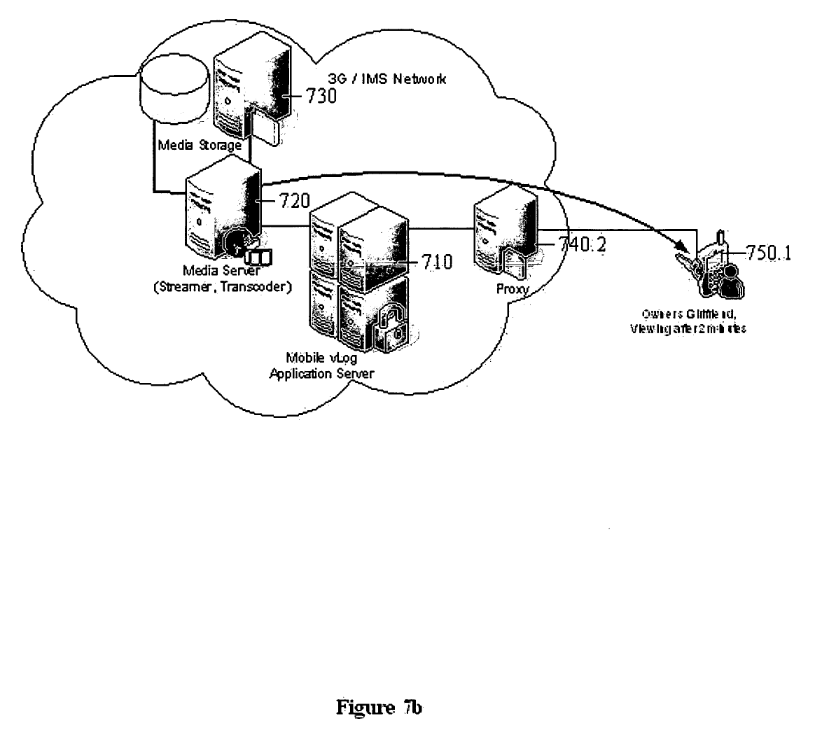

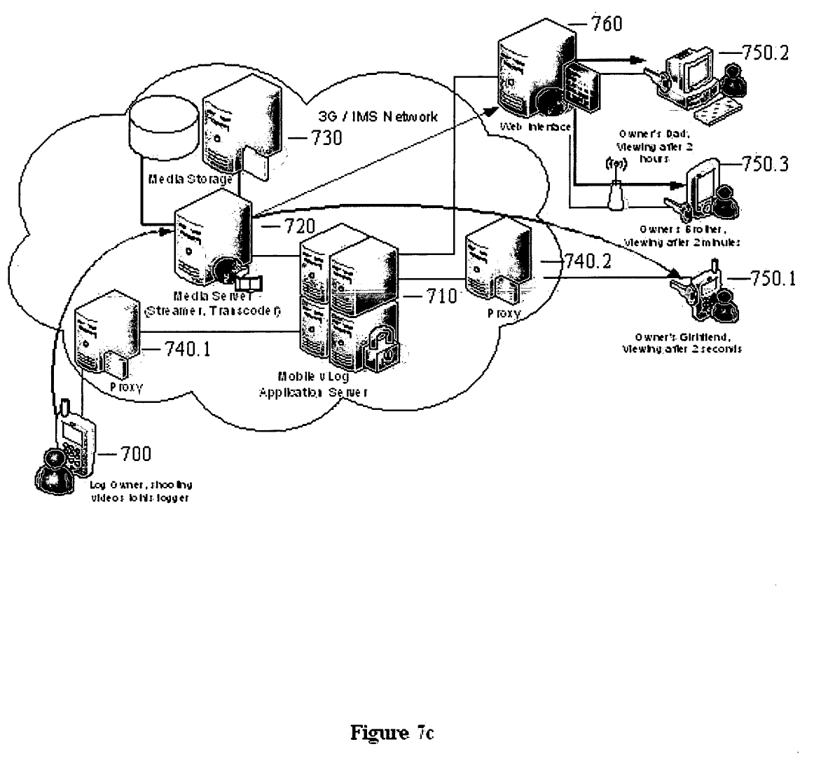

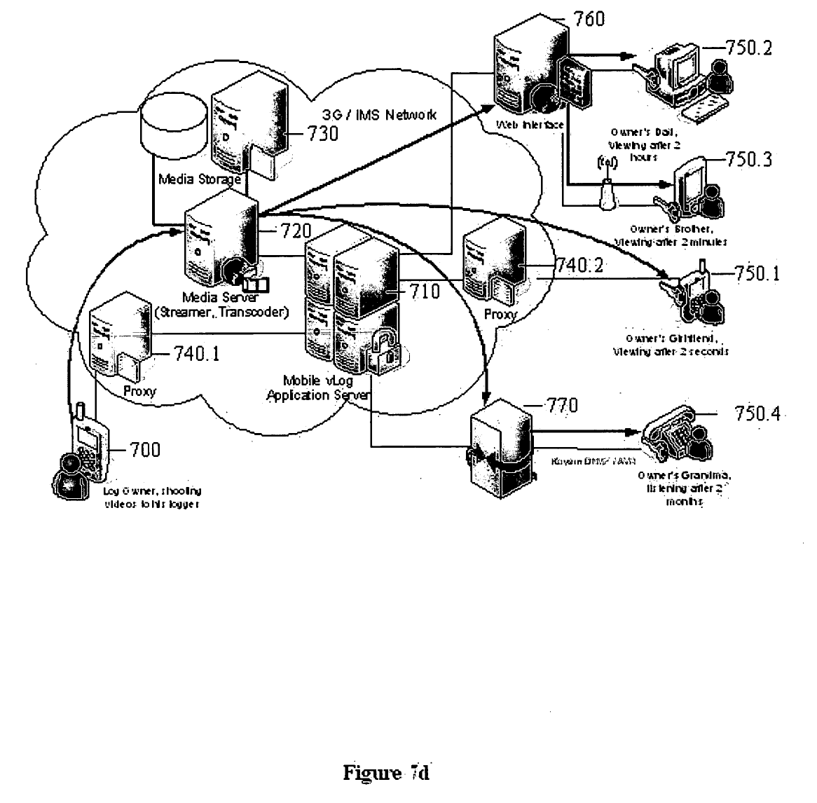

FIGS. 7a-7d show examples of system architectures for a multimedia mobile log server. FIG. 7a shows a multimedia server connected to a single user, the log owner 700. The multimedia server is composed of a Mobile vLog Application Server 710, a media server 720, a media storage 730, and a single proxy server 740.1 located in the signaling path between the user 700 and the multimedia server. In addition to the application logic, the application server 710 contains a user interface for managing log setup, establishing user preferences, specifying access privileges, and the like. The content is transferred between the users and the media server 720 by upload/download and by data streaming.

The media server 720 manages the communication of the multimedia content, under the control of the application logic on the application server 710. The media server 720 performs many functions, including: receiving multimedia content from the user 700, sending multimedia content to the user 700, transcoding, storing the content in logs located in the media storage 730, processing the multimedia content for storage, and retrieving the content to be viewed from the media storage 730.

The following three figures expand the basic architecture shown in FIG. 7a by adding interfaces for various types of accessing devices. FIG. 7b shows a multimedia server being accessed by a viewer 750.1 via a mobile telephone. The viewer 750.1 is not the log owner, and is permitted access to the mobile log only after SIM-based authentication or by logging on with a password. The viewer 750.1 accesses the mobile log by sending view requests to an application server 710 via proxy server 740.2. The application server 710 instructs the media server 720 to retrieve and process the requested log entries, and to download the requested entries to the mobile telephone of the viewer 750.1.

FIG. 7c shows a multimedia server with http-based Web interface server 760, which enables log access over the Internet. As detailed in the description of FIG. 7a, the log owner 700 deposits multimedia content to the media storage 730 via the media server 720. Viewer 750.1 accesses the a designated mobile log from the mobile telephone as explained above with reference to FIG. 7b, whereas viewer 750.2 accesses a designated mobile log from a personal computer, whereas viewer 750.3 accesses the mobile log from a PDA using the Web interface server 760. Finally, FIG. 7d shows a multimedia server with POTS interface 770 and an additional viewer 750.4. The viewer 750.4 can access audio log entries from a landline telephone using the POTS interface 770.

The multimedia servers, according to the exemplary embodiments presented above, are capable of receiving multimedia content over many channels. However, the channels which are available to a particular user are determined by the capabilities of the user's device.

While many mobile phones are now equipped with SMS, MMS, Internet, and email capabilities, other, potentially more effective, methods are not currently available to the mobile phone users. In particular, the mobile phones are not equipped for data streaming, thus limiting the size of audio and video clips, which can be sent to the mobile log server for logging. In the following exemplary embodiment, the capabilities of the wireless device are expanded by installing client software on the wireless, multimedia-enabled device. The client software enables the wireless device to input and output multimedia content in a format or protocol not provided with the wireless device. The client software preferably provides a simplified user interface, which is tailored to the needs of the user and to the wireless device itself.

In the exemplary embodiment, the logging client has media-transferring mechanisms such as RTP/RTSP, for upstreaming video and audio as they are being captured, with or without saving it locally. With RTP/RTSP, the mobile device acts as a wireless camera that sends live video to the server. The data transmitted to the server can also be saved or buffered locally, for backup purposes.

Preferably, the logging client uses one of the available protocols (i.e., HTTP, FTP, RTP/RTSP, etc.) to send the multimedia content from the wireless device after it is captured and saved. An automatic mechanism for sending the content may be activated immediately after the capture is stopped or at a later time.

In addition, it is advantageous that the logging client simplifies logging from the wireless device by pre-configuring logging parameters such as the destination for sending the multimedia content, in contrast to the regular email or MMS clients, which are not configured to support mobile logging. A graphical tag may be used to provide more specific storage information for an associated content item. For example, clicking the tag can send the media to a specific log sub-folder, with predefined access rights.

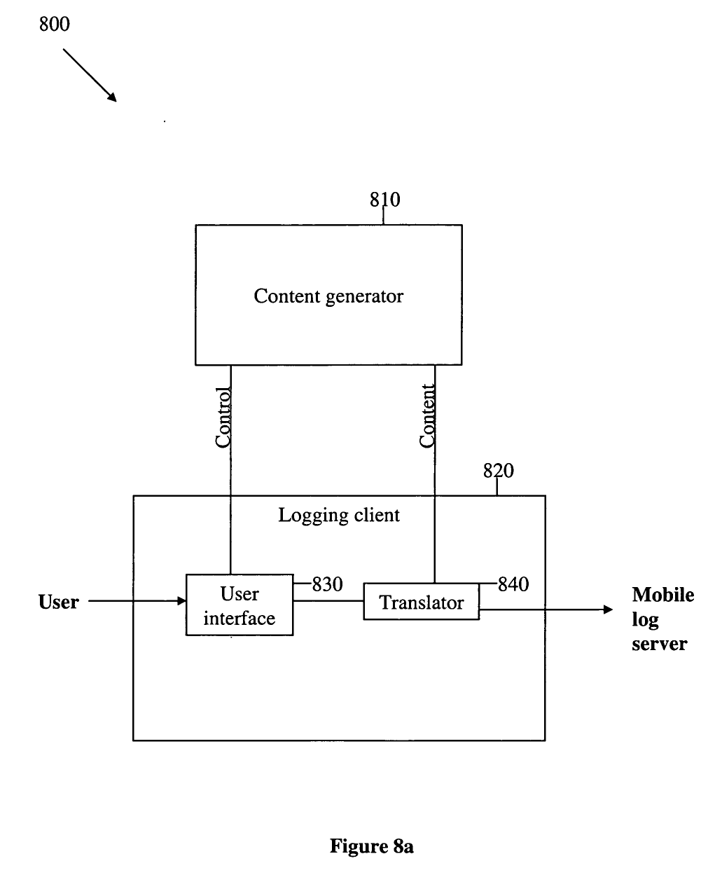

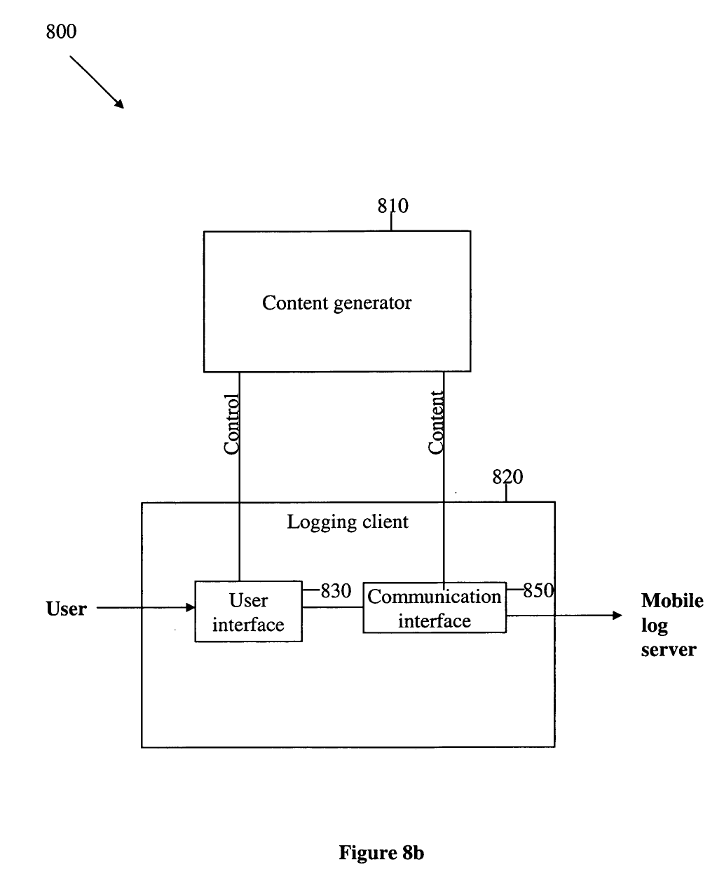

FIG. 8a is a simplified block diagram of a wireless device according to an exemplary embodiment of the present invention. The wireless device 800 contains multimedia content generator 810 and a logging client 820. The multimedia content generator 810 generates multimedia content items for storage in a multimedia mobile log. The multimedia content may also be content previously received from another source such as an MMS received from another mobile phone. The wireless device 800 may be a cell phone, a PDA, a Wi-Fi terminal, or a Bluetooth wireless device. Preferably, the wireless device 800 also has viewing capabilities for viewing mobile logs on a website, for example.

In this exemplary embodiment, the logging client 810 is installed on wireless device 800. The installed logging client 810 implements at least one wireless logging protocol for interfacing to a multimedia mobile log server. With the logging client installed, the wireless device 800 can communicate with a mobile log server using the protocols supported by logging client 820, in addition to the standard protocols. The communication between the wireless client and the multimedia server preferably includes one or more of: log setup, content transmission for logging, log viewing (both content and a log index), preference setting, and access rights establishment.

In the exemplary embodiment illustrated in FIG. 8, the logging client 820 equips the wireless device 800 with a logging user interface 830 for controlling logging functions. Preferably, the user interface 830 provides a quick and convenient way to select content for logging, to transmit the selected content to the mobile log, and to view logs. In particular, client interface 830 preferably provides one-touch functionality. The user selects a multimedia content item from a content list, and with a single touch transmits the content to the mobile log server. Logging client 820 thus eliminates the cumbersome process currently required, for example, for uploading MMS messages and images from a mobile phone.

The logging client 820 also contains a translator 840, which presents the multimedia content located on the wireless device in a format and/or protocol required by the mobile log server (analogous to the format conversion/transcoding performed on the mobile log server). The translator 840 preferably performs capabilities negotiation with the mobile log server to determine service-compatible format.

FIG. 8b is a simplified block diagram of a wireless device according to another exemplary embodiment of the present invention. Wireless device 800 contains a multimedia content generator 810 and a logging client 820. The multimedia content generator 810 operates essentially as described in FIG. 8a above, generating multimedia content items for storage in a multimedia mobile log. The logging client 820 provides a user interface 830 with one-touch functionality for the transmission of multimedia content to the multimedia server.

Preferably, the logging client 820 also includes a communication interface 850, which implements at least one wireless protocol for connecting to a multimedia mobile log server. The protocol(s) preferably permits communicating with the multimedia server using data streaming and/or a custom communication protocol.

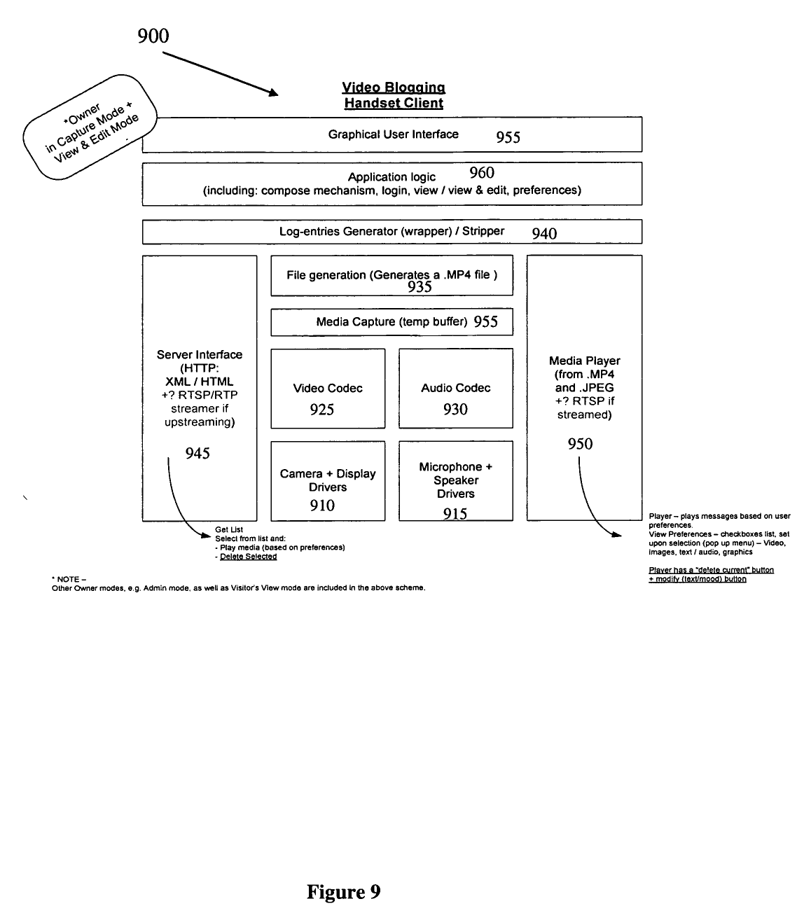

FIG. 9 is a simplified block diagram of a handset client according to an exemplary embodiment of the present invention. The handset client 900 contains components which support media composition, capture, and publishing. In the exemplary embodiment illustrated in FIG. 9, the handset client 900 contains a camera 910 and a microphone 915 (including drivers) to capture multimedia data. The captured data is optionally stored in the media capture buffer 920. The video and the audio codecs, 925 and 930, respectively, encode the raw data into a standard and efficient media format (and decode downloaded or downstreamed data). The file generator 935 converts the coded content into a file such as an MP4 file. When more than one types of content are to be sent as a single log entry, the log-entries generator 940 takes the separate components and wraps them together to form a single transferable log-entry. The log entry is sent to the log by the server interface 945, using a chosen protocol. The process is essentially reversed when content is received from the log. When the content is received from the log, the server interface 945 receives the entry from the network and presents it to the user (after handling streamed data if needed, unwrapping, decoding etc.). The handset client 900 includes a media player 950, which supports the presentation of received and stored media. The graphical user interface (GUI) 955 provides an efficient user control of the multimedia logging functions. The handset client components are controlled by application logic 960.

In an additional exemplary embodiment, a mobile logging system consists of a wireless device and a multimedia server. The multimedia server contains a communication handler, a log setup unit, and a data receiving unit. The communication handler interfaces with the wireless device, preferably using a wireless protocol. The log setup unit sets up a wireless log for the mobile device and designates user access rights. The data receiving unit receives the multimedia content sent from the wireless device and enters the received content into a designated mobile log.

In this exemplary embodiment, the wireless device has a multimedia content generator for generating multimedia content items and a logging client. The logging client implements at least one wireless logging protocol and/or provides a dedicated user interface for mobile logging, preferably with one-touch functionality. When the wireless device contains a logging client, the communication handler preferably interfaces directly with the logging client.

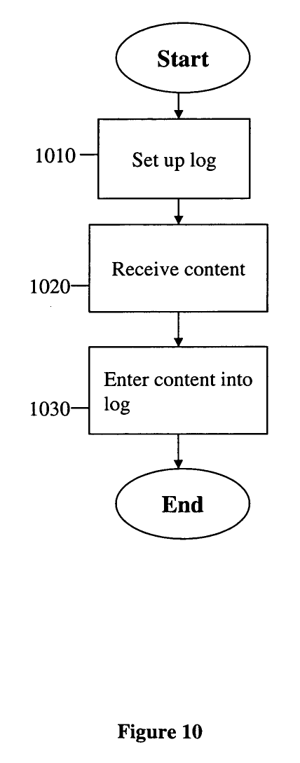

FIG. 10 is a simplified flowchart of a method for providing a multimedia mobile log according to an exemplary embodiment of the present invention. In step 1010, a multimedia mobile log is set up on a mobile log server and user access rights are designated for the mobile log. In step 1020, multimedia content is received for the multimedia mobile log established in step 1010 by communicating with a wireless source, such as a mobile phone or a PDA, using a wireless protocol. The content is entered into a designated mobile log in step 1030. The multimedia content preferably includes an audio clip, a video clip, a text message, an image, an audio stream, a video stream, and/or a tag. The interfacing may be performed by one of the following methods: SMS, MMS, email, telephony signal, Internet, data upstreaming, and data upload. Preferably, the method contains an additional step of entering the received content into the mobile log. Also, the method may contain the additional step of downloading or downstreaming log entries to a user viewing said multimedia mobile log and/or the step of ensuring user access rights prior to permitting access to a specified mobile log.

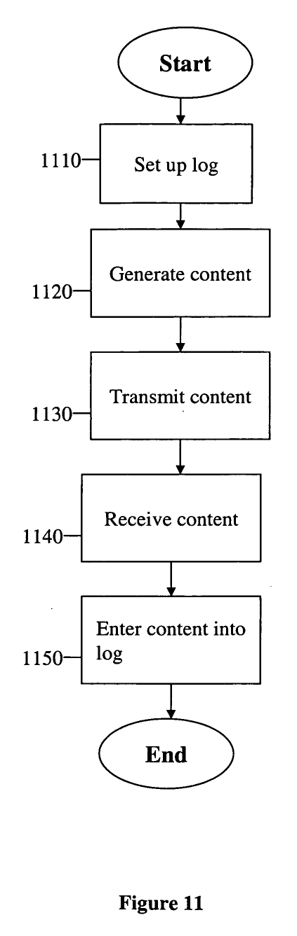

FIG. 11 is a simplified flowchart of a method for wireless mobile logging according to an exemplary embodiment of the present invention. In step 1110, a mobile log is set up on a multimedia server and user access rights are designated for the mobile log. In step 1120, multimedia content is created on a wireless device. The content is transmitted from the device to the multimedia server in step 1130. The content is received at the mobile log server in step 1140, and entered into a designated mobile log in step 1150. Format conversion/transcoding is preferably and optionally performed by the wireless device and/or the multimedia server, to facilitate communication between the multimedia server and the wireless device.

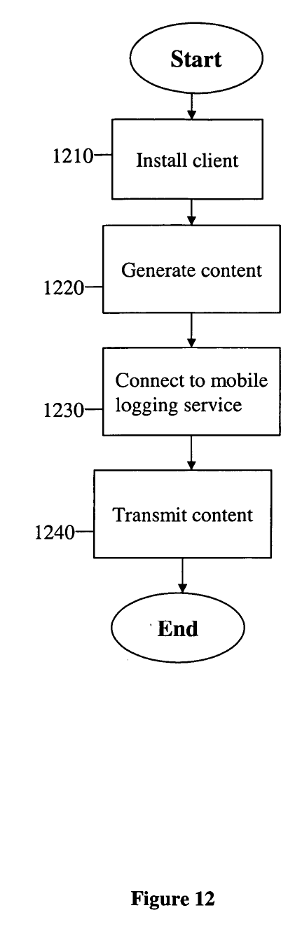

FIG. 12 is a simplified flowchart of a method for mobile logging from a wireless device according to an exemplary embodiment of the present invention. In step 1210, a logging client is installed on a wireless device. The logging client preferably provides additional data communication formats and/or a user interface for performing log-related functions. In step 1220, a multimedia content is generated on the wireless device. The user connects to a mobile logging service using the client software, in step 1230. Finally, in step 1240, the multimedia content is transmitted to a mobile log service for entry into a designated mobile log. The method preferably and optionally contains one or both of the following steps: selecting the multimedia content for transmission from a group of content items available on the wireless device and viewing the mobile log from the wireless device. Preferably, content transmission is by one of the following: SMS, MMS, email, telephony signal, Internet, data upstreaming, and data upload.

The popularity of web logging continues to rise. Logging has developed as a new mean of communication, forming instant communities worldwide. Logging fulfils people's need to express themselves, and to document and to share their lives. Mobile logging, in particular, enables users to log new content anytime and anywhere from their mobile phones.

On the business side, mobile logs can assist managers to give voice or video instructions to their employees, traveling salesmen to provide status reports, and field engineers to document their work for the home office. Many mobile logging systems are possible including:

1) Medical Storage Platform for doctors to capture and store patient information for later review,

2) Digital Newspapers for reporters to capture and publish content anywhere and anytime,

3) Personal Broadcasting Stations,

4) Business applications for remote management,

5) Personal VJ (Video Jockey) for generating music videos by combining branded media and user generated content,

6) Networked archiving for instant audio/video communication mechanisms such as Comverse's Push-to-Show™ (PTS) and Nextel's Push-to-Talk (PTT), where users send each other live streams of audio and/or video. Conventional techniques do not provide the capability to hear and/or view missed bursts.

The above exemplary embodiments present a multimedia mobile logging server which can provide multimodal logging services for a wide range of media types, media formats, and communication protocols and channels. A logging client expands the wireless device capabilities to facilitate the creation and transmission of content between the wireless device and the mobile log. The mobile log infrastructure may be hosted by a cellular operator, an Internet service provider, or by a dedicated mobile log service provider, serving as a means of increasing customer loyalty. The increased traffic resulting from mobile logging is a significant new revenue source for cellular operators. ISPs and mobile application service providers are well equipped to handle the external content interfaces required to support this popular mobile application.

It is expected that during the life of this patent many relevant wireless devices, wireless protocols, multimedia content formats, multimedia logs, web logs, mobile logs, and logging services will be developed and the scope of the term wireless device, wireless protocol, multimedia content format, multimedia log, web log, mobile log, and logging service is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The above description of illustrative, non-limiting embodiments has been given by way of an example. The above and other features of the invention including various novel method steps and a system and a device of the various novel components have been particularly described with reference to the accompanying drawings and pointed out in the claims. It will be understood that the particular process and construction of parts embodying the invention is shown by way of an illustration only and not as a limitation of the invention. The principles and features of this invention may be employed in varied and numerous embodiments without departing from the scope of the invention as defined by the appended claims and equivalents thereof.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A multimedia server comprising:
a communication handler interfacing to at least one wireless protocol;
a log setup unit, associated with said communication handler, setting up a mobile log and designating user access rights; and
a data receiving unit, associated with said communication handler, receiving multimedia content from a wireless source and entering said received content into a designated mobile log.

2. A multimedia server according to claim 1, wherein said mobile log comprises a web site.

3. A multimedia server according to claim 1, wherein said mobile log is accessible over a network.

4. A multimedia server according to claim 1, further comprising a log accessor, associated with said communication handler, providing user access to said mobile logs.

5. A multimedia server according to claim 1, wherein said data receiving unit is operable to ensure user access rights prior to permitting content logging.

6. A multimedia server according to claim 1, wherein said log is set up in a network-accessible centralized storage device with presentation capabilities.

7. A multimedia server according to claim 1, further comprising a log storage memory storing said mobile logs.

8. A multimedia server according to claim 1, wherein said data receiving unit is operable to link multiple multimedia content items to form a single mobile log entry.

9. A multimedia server according to claim 4, wherein said log accessor is operable to ensure user access rights prior to permitting access to a given mobile log.

10. A multimedia server according to claim 4, wherein said log accessor is operable to provide multiple users with controllable access to a given mobile log, in accordance with respective designated access rights.

11. A multimedia server according to claim 1, wherein said mobile log access rights are changeable by at least one of said users.

12. A multimedia server according to claim 1, wherein said wireless protocol comprises a custom protocol providable as a service to said wireless source.

13. A multimedia server according to claim 1, wherein said multimedia content comprises an audio clip.

14. A multimedia server according to claim 1, wherein said multimedia content comprises a video clip.

15. A multimedia server according to claim 1, wherein said multimedia content comprises a text message.

16. A multimedia server according to claim 1, wherein said multimedia content comprises an image.

17. A multimedia server according to claim 1, wherein said multimedia content comprises an audio stream.

18. A multimedia server according to claim 1, wherein said multimedia content comprises a video stream.

19. A multimedia server according to claim 1, wherein said multimedia content comprises a tag.

20. A multimedia server according to claim 19, wherein said tag comprises one of: a mood stamp, a media type, a content descriptor, a content destination specifier, an icon, and an access rights descriptor.

21. A multimedia server according to claim 19, wherein said tag is represented by a graphical icon.

22. A multimedia server according to claim 1, wherein said communication handler comprises an SMS interface configured to receive SMS multimedia content.

23. A multimedia server according to claim 1, wherein said communication handler comprises an MMS interface configured to receive MMS multimedia content.

24. A multimedia server according to claim 1, wherein said communication handler comprises an email interface configured to communicate multimedia content by email.

25. A multimedia server according to claim 1, wherein said communication handler comprises an Internet interface configured to communicate multimedia content over the Internet.

26. A multimedia server according to claim 1, wherein said communication handler comprises a signal interface configured to perform audio signal communications.

27. A multimedia server according to claim 26, where said audio signal comprises an audio telephony signal transmitted over a telephony network.

28. A multimedia server according to claim 27, where said telephone network comprises a Public Switched Telephone Network (PSTN) interface.

29. A multimedia server according to claim 27, where said telephone network comprises a cellular telephone network.

30. A multimedia server according to claim 26, wherein said audio interface is operable to digitize said received audio telephony signal.

31. A multimedia server according to claim 1, wherein said communication handler comprises a data upstreamer for receiving upstreamed multimedia content.

32. A multimedia server according to claim 1, wherein said communication handler is operable to upload multimedia content.

33. A multimedia server according to claim 1, wherein said communication handler comprises a data downstreamer for downstreaming mobile log entries.

34. A multimedia server according to claim 4, wherein said communication handler is operable to download mobile log entries.

35. A multimedia server according to claim 4, wherein said log accessor is operable to provide a mobile log content index.

36. A multimedia server according to claim 4, wherein said log accessor is operable to filter a mobile log by parameters associated with mobile log entries.

37. A multimedia server according to claim 4, wherein said log accessor comprises a format converter for converting a mobile log entry accessed by a user into a user-compatible format.

38. A multimedia server according to claim 1, further comprising a negotiator performing a capabilities negotiation with an accessing device to determine device capabilities.

39. A multimedia server according to claim 38, wherein said capabilities comprise user-compatible formats for accessing said mobile log.

40. A multimedia server according to claim 38, wherein said capabilities comprise user-compatible communication protocols.

41. A multimedia server according to claim 1, further comprising a database for storing administrative data associated with said logs.

42. A multimedia server according to claim 1, wherein at least one user using said multimedia server is billed.

43. A multimedia server comprising:
a communication handler interfacing with a wireless device;
a log setup unit, associated with said communication handler, setting up at least one mobile log and designating user access rights; and
a data receiving unit, associated with said communication handler, receiving multimedia content transmitted by said wireless device and entering said received content into a designated mobile log from the at least one mobile log.

44. A multimedia server according to claim 43, further comprising a log accessor, associated with said communication handler, providing user access to said at least one mobile log.

45. A multimedia server according to claim 43, wherein said data receiving unit is operable to ensure user access rights prior to permitting content logging.

46. A multimedia server according to claim 43, further comprising a log storage memory for storing said at least one mobile log.

47. A multimedia server according to claim 43, wherein said data receiving unit is operable to link multiple multimedia content items to form a single mobile log entry.

48. A multimedia server according to claim 44, wherein said log accessor is operable to ensure user access rights prior to permitting access to a given mobile log.

49. A multimedia server according to claim 44, wherein said log accessor is operable to provide multiple users with controllable access to a given mobile log from said at least one mobile logs, in accordance with respective designated access rights.

50. A multimedia server according to claim 49, wherein said mobile log access rights are changeable by at least one of said users.

51. A multimedia server according to claim 43, wherein said interfacing is performed by a custom protocol.

52. A multimedia server according to claim 43, wherein said interfacing is performed by data streaming.

53. A multimedia server according to claim 43, wherein said multimedia content comprises an audio clip.

54. A multimedia server according to claim 43, wherein said multimedia content comprises a video clip.

55. A multimedia server according to claim 43, wherein said multimedia content comprises a text message.

56. A multimedia server according to claim 43, wherein said multimedia content comprises an image.

57. A multimedia server according to claim 43, wherein said multimedia content comprises an audio stream.

58. A multimedia server according to claim 52, wherein said multimedia content comprises a video stream.

59. A multimedia server according to claim 43, wherein said multimedia content comprises a tag.

60. A multimedia server according to claim 59, wherein said tag comprises at least one of: a mood stamp, a media type, a content descriptor, a content destination specifier, an icon, and an access rights descriptor.

61. A multimedia server according to claim 43, wherein said communication handler comprises an SMS interface receiving SMS multimedia content.

62. A multimedia server according to claim 43, wherein said communication handler comprises an MMS interface receiving MMS multimedia content.

63. A multimedia server according to claim 43, wherein said communication handler comprises an email interface communicating multimedia content by email.

64. A multimedia server according to claim 43, wherein said communication handler comprises an Internet interface communicating multimedia content over the Internet.

65. A multimedia server according to claim 43, wherein said communication handler comprises a signal interface performing audio signal communications.

66. A multimedia server according to claim 65, where said audio signal comprises an audio telephony signal transmitted over a telephony network.

67. A multimedia server according to claim 66, where said telephone network comprises a Public Switched Telephone Network (PSTN) interface.

68. A multimedia server according to claim 66, where said telephone network comprises a cellular telephone network.

69. A multimedia server according to claim 65, wherein said audio interface is operable to digitize received audio telephony signal.

70. A multimedia server according to claim 43, wherein said communication handler comprises a data upstreamer receiving upstreamed multimedia content.

71. A multimedia server according to claim 43, wherein said communication handler is operable to upload multimedia content.

72. A multimedia server according to claim 43, wherein said communication handler comprises a data downstreamer for downstreaming mobile log entries.

73. A multimedia server according to claim 44, wherein said communication handler is operable to download mobile log entries.

74. A multimedia server according to claim 44, wherein said log accessor is operable to provide a mobile log content index.

75. A multimedia server according to claim 44, wherein said log accessor is operable to filter a mobile log by parameters associated with mobile log entries of said mobile log.

76. A multimedia server according to claim 44, wherein said log accessor comprises a format converter for converting a mobile log entry accessed by a user into a user-compatible format.

77. A multimedia server according to claim 43, further comprising a negotiator performing a capabilities negotiation with at least one of an accessing device and the wireless device, to determine device capabilities.

78. A multimedia server according to claim 77, wherein said capabilities comprise user-compatible formats for accessing said mobile logs.

79. A multimedia server according to claim 77, wherein said capabilities comprise user-compatible communication protocols.

80. A multimedia server according to claim 43, further comprising a database for storing administrative data associated with said logs.

81. A multimedia server according to claim 43, wherein said wireless device is billed in accordance with usage of the multimedia server.

82. A multimedia server comprising:
a log setup unit setting up mobile logs and designating user access rights for said mobile logs; and
a data receiving unit, associated with said log setup unit, receiving up,streamed multimedia content from a wireless source and entering said received content into a designated mobile log from said mobile logs.

83. A multimedia server according to claim 82, wherein said multimedia content comprises an audio stream.

84. A multimedia server according to claim 82, wherein said multimedia content comprises a video stream.

85. A multimedia server according to claim 82, further comprising a log accessor, for providing user access to said mobile logs.

86. A multimedia server according to claim 85, wherein said log access unit comprises a data downstreamer downstreaming mobile log entries.

87. A multimedia server comprising:
a communication handler interfacing to at least one wireless protocol;
a log setup unit, associated with said communication handler, setting up mobile logs and designating user access rights for each of said mobile logs; and
a data receiving unit, associated with said communication handler, receiving audio content in a digital format from a wireless source and entering said received audio content into a designated mobile log from said mobile logs.

88. A multimedia server according to claim 87, wherein said entering creates an audio-only mobile log entry.

89. A multimedia server according to claim 87, further comprising a log accessor providing user access to said mobile logs.

90. A wireless device, comprising:
a multimedia content generator generating multimedia content items; and
a logging client implementing at least one wireless logging protocol for interfacing to a multimedia mobile log server to log said multimedia content items into a mobile log at said server.

91. A wireless device according to claim 90, wherein said logging protocol comprises data streaming.

92. A wireless device according to claim 90, wherein said logging protocol comprises a custom protocol.

93. A wireless device according to claim 90, wherein said logging client communicates multimedia content to said mobile log server using an implemented wireless logging protocol.

94. A wireless device according to claim 90, wherein said logging client comprises a user interface providing user control of mobile logging functions.

95. A wireless device according to claim 94, wherein said control comprises selecting multimedia content for transmission to said mobile log server.

96. A wireless device according to claim 94, wherein said control comprises one-touch sending of multimedia content.

97. A wireless device according to claim 94, wherein said control comprises setting up a mobile log on the mobile log server and designating user access rights.

98. A wireless device according to claim 90, wherein said logging client comprises a format translator for converting said multimedia content to a service-compatible format.

99. A wireless device according to claim 98, wherein said format translator is operable to perform a capabilities negotiation with said mobile log server to determine said service-compatible format.

100. A wireless device according to claim 90, wherein said generating comprises receiving said content from an external source.

101. A wireless device according to claim 90, wherein said device comprises a cellular telephone.

102. A wireless device according to claim 90, wherein said device comprises a PDA.

103. A wireless device according to claim 90, wherein said device comprises Bluetooth functionality.

104. A wireless device comprising:
a multimedia content generator generating multimedia content items; and
a logging client providing a dedicated mobile logging user interface.

105. A wireless device according to claim 104, wherein said user interface is operable to provide one-touch sending of multimedia content for logging by a multimedia mobile log server.

106. A wireless device according to claim 104, wherein the logging client comprises a communication interface implementing at least one wireless logging protocol for interfacing to a multimedia mobile log server.

107. A wireless device comprising:
a multimedia content generator generating multimedia content items; and
a logging client comprising:
a media capture buffer storing captured data;
a coder encoding the captured data into a content item having a specified media format;
a log-entries generator combining multiple content items into at least one transmittable log entry;
a server interface sending and receiving said at least one log entry; and
a graphical user interface interfacing with a user.

108. A wireless device according to claim 107, wherein said logging client further comprises a media player presenting the at least one log entry.

109. A wireless device according to claim 107, wherein said logging client further comprises a file generator converting coded data into a data file.

110. A wireless device according to claim 107, further comprising an application logic layer controlling said logging client.

111. A wireless device according to claim 107, wherein said coder is operable to decode received content items.

112. A mobile logging system comprising:
a wireless device generating and sending multimedia content; and
a multimedia server associated with said wireless device, comprising:
a communication handler interfacing to said wireless device;
a log setup unit, associated with said communication handler, setting up a wireless log and designating user access rights; and
a data receiving unit, associated with said communication handler, receiving multimedia content from said wireless device and entering said received content into a designated mobile log.

113. A mobile logging system according to claim 112, wherein said interfacing is performed using a wireless protocol.

114. A mobile logging system according to claim 112, wherein said wireless device comprises:
a multimedia content generator generating multimedia content items; and
a logging client implementing at least one wireless logging protocol for interfacing with the multimedia log server, to log said multimedia content items into the mobile log at said server.

115. A mobile logging system according to claim 112, wherein said wireless device comprises:
a multimedia content generator generating multimedia content items; and
a logging client providing a dedicated mobile logging user interface.

116. A wireless device according to claim 115, wherein said user interface is operable to provide one-touch sending of the multimedia content for logging by the multimedia server.

117. A mobile logging system according to claim 114, wherein said interfacing is with said logging client.

118. A mobile logging system according to claim 115, wherein said interfacing is with said logging client.

119. A method for providing a multimedia mobile log, comprising:
setting up a mobile log and designating user access rights;
receiving multimedia content for said mobile log from a wireless device using a wireless protocol; and
entering said received content into a designated mobile log.

120. A method for providing a multimedia mobile log according to claim 119, wherein said setting up is carried out using said wireless protocol.

121. A method for providing a multimedia mobile log according to claim 119, further comprising sending log entries to a user viewing said multimedia mobile log.

122. A method for providing a multimedia mobile log according to claim 119, further comprising ensuring user access rights prior to permitting a user access to a given mobile log.

123. A method for providing a multimedia mobile log according to claim 119, wherein said multimedia content comprises at least one of a group of multimedia content comprising: an audio clip, a video clip, a text message, an image, an audio stream, a video stream and a tag.

124. A method for providing a multimedia mobile log according to claim 119, wherein said interfacing is compatible with at least one of a group of formats comprising: SMS, MMS, email, telephony signal, Internet, data upstreaming, and data upload.

125. A method for wireless mobile logging, comprising:
setting up a mobile log on a multimedia server and designating user access rights;
creating multimedia content on a wireless device;
sending said multimedia content from said wireless device to said multimedia server; and
entering said sent content into a designated mobile log.

126. A method for wireless mobile logging according to claim 125, further comprising performing format conversion to enable communication between said multimedia server and said wireless device.

127. A method for mobile logging from a wireless device, comprising:
installing a logging client on a wireless device;
generating multimedia content on said wireless device;
connecting to a mobile log service via said logging client; and
transmitting said multimedia content to said mobile log service for entry into a designated log.

128. A method for mobile logging from a wireless device according to claim 127, further comprising selecting said multimedia content from a group of content items available on said wireless device.

129. A method for mobile logging from a wireless device according to claim 127, further comprising viewing said log from said wireless device.

130. A method for mobile logging from a wireless device according to claim 127, wherein said transmitting is by one of a group comprising: SMS, MMS, email, telephony signal, Internet, data upstreaming, and data upload.

131. A multimedia server comprising:
means for interfacing to at least one wireless protocol;
setup means for setting up mobile logs and for designating user access rights; and
receiving means for receiving multimedia content from a wireless source and for entering said received content into a designated mobile log.

132. The multimedia server according to claim 131, wherein said interfacing means comprises at least three of:
SMS means for interfacing with SMS multimedia content;
MMS means for interfacing with MMS multimedia content;
Email means for interfacing with the multimedia content received in an email;
Internet means for interfacing with the multimedia content received over Internet;
audio means for interfacing with audio multimedia content;
specialized means for interfacing with the multimedia content in a custom format;
upstream means for receiving upstreamed multimedia content; and
downstream means for downstreaming the multimedia content.

133. The multimedia server according to claim 132, wherein said communication handler is adopted to interface with the multimedia content comprising an audio clip, a video clip, a text message, an image, an audio stream, a video stream, and a tag.
